(19) United States
(12) Patent Application Publication
(10) Pub. No.: US 2024/0273245 A1
(43) Pub. Date: Aug. 15, 2024

(54) DESIGN OF INTELLIGENT RESILIENT STRUCTURES VIA AUTOMATIC PLACEMENT OF SENSOR AND SMART ACTUATORS

(71) Applicant: Palo Alto Research Center Incorporated, Palo Alto, CA (US)

(72) Inventors: Anurag BHATTACHARYYA, Mountain View, CA (US); Raman GOYAL, Mountain View, CA (US); Amirmassoud MIRZENDEHDEL, Millbrae, CA (US); Morad BEHANDISH, San Mateo, CA (US)

(21) Appl. No.: 18/168,011

(22) Filed: Feb. 13, 2023

(51) Int. Cl. G06F 30/10

(52) U.S. Cl. CPC G06F 30/10; G06F 2119/02

(57) ABSTRACT

An innovative method to automatically place sensors and stimuli-sensitive active actuators to neutralize the effects of structural faults and design a smart fault-resilient system is described. To the best of our knowledge, the proposed framework is the first systematic integration of thermally activated shape memory polymer actuators with a sensor distribution framework targeted to bring a damaged structural system to its native state. The framework does not explicitly model the material constitutive model and hence can be applied to linear and nonlinear material behaviors. The approach enables the design of resilient smart structures that can be additively manufactured. The framework computes a matrix of relative importance for different sensor positions and uses that to optimally place actuators to reconfigure the system in presence of faults.

### FEDERALLY SPONSORED RESEARCH AND DEVELOPMENT

N/A

### JOINT RESEARCH AGREEMENT

N/A

### BACKGROUND OF THE INVENTION

The present application generally relates to designing resilient structures that can absorb or avoid damage without complete failure and, more specifically, using actuators that change their shape in response to stimuli, such as actuators based on shape-memory polymers and shape-memory alloys.

The design of resilient systems has been investigated from a robust design perspective where optimal design is sought under uncertainties in material, loading, and more. Researchers have investigated the use of tools like topology optimization with piezoelectric materials for active vibration control. Investigations have also been done to use shape memory alloys (SMA) for the reliability-based design of structures [5]. See the incorporated references [1] through [17] listed in the Invention Disclosure Statement and listed at the end of this document.

Topology optimization, along with shape optimization, has been investigated to design automatic robots with dielectric materials [1]. Topology optimization has been investigated for wireless sensor fault mitigation [2]. These investigations by researchers attempt to integrate the optimal placement of sensors and smart actuators for fault detection and correction while making sure that the generated designs can be additively manufactured.

Further, the design of resilient systems have been investigated from robust design perspective where optimal design is sought under uncertainties in material, loading etc. [6][7]. Researchers have investigated the use of tools like topology optimization with piezoelectric materials for active vibration control [8][9]. Investigations have also been done to use shape memory alloys (SMA) for reliability based design of structures [10][11]. Topology optimization and shape optimization have been investigated to design automatic robots with dielectric materials [12]. Zhang et al. [13] investigated the design of piezoelectric structures that consumes minimum energy for active vibration control using topology optimization. Townsend et al. [14] investigated the use of topology optimization to tailor the resonant behavior of cantilever structures to harness vibrations for powering piezoelectric sensors. Topology optimization has been investigated for wireless sensor fault mitigation [15]. Lumpe et al. investigated the use of shape memory polymers to design reconfigurable structures. They investigated the optimal placement of SMP structures through a combination of interior point optimization (IPOPT) and Genetic Algorithm (GA) [16].

### SUMMARY OF THE INVENTION

Disclose an innovative method to automatically place sensors and stimuli-sensitive active actuators to neutralize the effects of structural faults and design a smart fault-resilient system. The proposed framework is a systematic integration of thermally activated shape memory polymer actuators with a sensor distribution framework targeted to bring a damaged structural system to its native state. The framework does not explicitly model the material constitutive model and hence can be applied to linear and nonlinear material behaviors. The approach enables the design of resilient smart structures that can be additively manufactured. The framework computes a matrix of relative importance for different sensor positions and uses that to optimally place actuators to reconfigure the system in the presence of faults.

More specifically, in one example, the present invention provides the designer the ability to place a limited number of strain sensors on a structure such that their collective gain is maximized against structural breakdowns and optimally place a limited number of stimuli sensitive actuators to neutralize the negative effects of any structural faults measured by the sensors. The framework is based on a novel Solid Isotropic Material with Penalization (SIMP) based formulation for optimal placement of sensors and smart actuators to design a resilient truss. The framework treats each bar as a potential smart actuator capable of producing axial forces. The axial forces from each active bar along with the external forces acting on the structure are superimposed to form a global external force vector used for the design optimization. A multilevel topology optimization problem is formulated to integrate the effects of sensor position and actuator position.

More specifically, disclosed is a system and method for placing sensors on a truss structure. The truss structure is formed from members connected by nodes. The truss members include passive structures and structures formed with stimuli sensitive actuators. Information derived from the placement of sensors on truss members is used to guide the placement of stimuli sensitive actuators to design an active resilient structure design.

The method begins with receiving an initial design domain for a truss structure formed from a plurality of members connected by nodes.

In one example, the initial design for the truss structure includes receiving the initial design with 1) boundary conditions, ii) loading conditions, or iii) both.

In another example, the initial design domain for the truss structure includes receiving one or more boundary conditions, loading conditions, or a combination thereof.

Next, a mathematical array of sensor placement sensitivity is created by successively measuring, for each respective sensor disposed on a respective member of a plurality of members comprising the truss structure, a respective relative change in structural response based on applying respective faults on other members of the plurality of members other than the respective member.

Next, an iterative loop is executed in which iteratively using the mathematical array of sensor placement sensitivity to evaluate different locations for groups of sensors disposed on the plurality of members in the truss structure, to measure a change in the structural response until at least one of i) a predefined number of actuators is reached, ii) a predefined number of sensors is reached, iii) a predefined computational budget is reached, or iv) a predefined computational performance is reached.

Next, based on the evaluation of the different locations of each sensor, locations of a fewest number of sensors in the groups of sensors are identified that produce a relatively larger measured change in the structural response for a given location of a fault.

A design workflow is produced with placement of actuators to generate one or more active resilient structure designs based on the locations of the fewest number of sensors that produce the relatively larger measured change in the structural response, in order to neutralize the effects of a planned fault on the truss structure.

In one example, the design workflow to generate one or more designs uses additive manufacturing to form one or more of the actuators.

In another example, the design workflow includes at least one of i) actuators that change their shape in response to stimuli, ii) passive material that does not change its shape in response to stimuli, and iii) materials that have one or more voids.

In another example, wherein the producing the design workflow to generate one or more designs of with placement of actuators includes simplifying a modeling an output force of an actuator in response to stimuli as a linear equation.

In still another example, the design workflow includes producing the design workflow for one or more portions based on one of boundary conditions and loading conditions.

In yet still another example, receiving one or more simulated faults; and evaluating the one or more designs produced by the design workflow in response to the one or more simulated faults.

### BRIEF DESCRIPTION OF DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example of an actuator that changes its shape in response to thermal stimuli as used in an active resilient truss structure;

FIG. 2 is an example matrix illustrating strain measured by sensors placed on truss members while the cross-sectional areas associated with all other truss members are perturbed in reference equation 2 and measured on a truss design in FIG. 3;

FIG. 3 represents the boundary conditions and force conditions on a truss domain with 11 element;

FIG. 4 is an example truss structure that illustrates the optimized placement of the sensor that maximized the parameter s under the constraint of the availability of only two sensors;

FIG. 5 illustrates an example of the modified thermo-mechanical SMP programming cycle;

FIG. 6 illustrates an example of possible actuator angles in the truss design domain;

FIG. 7 is an example table illustrating a comparison of the damaged optimized structural behavior with the healthy structure with a specified number of available actuators with 50% damage to a truss member;

FIG. 8 is an example of the optimal position of actuators to reconfigure a damaged truss structure back to its healthy state;

FIG. 9 is an example flowchart describing the transfer of information between different modules of the framework is shown in FIG. 8 and more specifically, the multi-level design optimization framework for fault-tolerant resilient structures;

FIG. 10 is a conceptual representation of different materials inside a truss member within one design domain Ω out of all possible design domains to;

FIG. 11 is a conceptual representation of different materials possible inside a truss member;

FIG. 12 is a truss domain with a bar having degrees-of-freedom as a, b, c and d;

FIG. 13 is a sensor sensitivity matrix G for a truss with 11 elements;

FIG. 14A through FIG. 14B is a truss design with 11 truss bars, with element numbers shown and optimal placement of 2 sensors;

FIG. 15 is a cantilever truss domain with element numbers;

FIG. 16a through FIG. 16f is the cantilever truss domain of FIG. 15 illustrating the optimal placement of sensors on a cantilever beam domain with different Nₘₐₓ^{s} values;

FIG. 17 is a MBB beam with truss elements;

FIG. 18a through FIG. 18c Optimal placement of sensors on a Messerschmitt-Bölkow-Blohm (MBB) beam domain with different Nₘₐₓ^{s} values;

FIG. 19 is a shows the convergence plot for optimal sensor placement with Nₘₐₓ^{s}=4 with the KKT tolerance set to 10⁻⁵.

FIG. 20 is an illustration of an actuator force output inside truss domain;

FIG. 21 is a plot of temperature vs Force plot for SMP actuator;

FIG. 22a through FIG. 22d illustrates an optimal placement of smart actuators, where FIG. 22a illustrates cantilever domain with truss elements, FIG. 22b illustrates the Placement of single smart actuator to minimize bending deformation of cantilever domain, FIG. 22c illustrates the truss domain under uniaxial tensile loading and FIG. 22d illustrates the placement of single smart actuator to minimize displacement under uniaxial loading;

FIG. 23a through FIG. 23f illustrates the optimal placement of actuators with Nₘₐₓ^{a}=1 for different locations of faulty member bars with initial conditions shown in FIG. 15;

FIG. 24a through FIG. 24h illustrates an optimal placement of actuators with Nₘₐₓ^{s}=15 for different structural damage levels;

FIG. 25 illustrates an optimal placement of actuators with Nₘₐₓ^{a}=15 for different structural damage levels;

FIG. 26 is a normalized objective vs Iterations plot for actuator placement with Nₘₐₓ^{a}=10 for initial conditions shown in FIG. 17 and with 5% of member bars damaged;

FIG. 27a through FIG. 27b is a probability of different member bars to be replaced by an actuator for different damage levels with Nₘₐₓ^{a}=10; and

FIG. 28 illustrates an example of computer architecture that can implement the methods described herein.

### DETAILED DESCRIPTION OF THE INVENTION

As required, detailed embodiments are disclosed herein; however, it is to be understood that the disclosed embodiments are merely examples and that the systems and methods described below are embodied in various forms. Therefore, specific structural and functional details disclosed herein are not to be interpreted as limiting but merely as a basis for the claims and as a representative basis for teaching one skilled in the art to variously employ the disclosed subject matter in virtually any appropriately detailed structure and function. Further, the terms and phrases used herein are not intended to be limiting but rather to provide an understandable description.

### INTRODUCTION

The term “Resilient” from a structural perspective refers to the ability of a structure to withstand, adapt to changing conditions and recover positively from damages, shocks and stresses [6]. Design of damage tolerant structures have been investigated for applications in various domains like civil engineering, robotics, aviation and aerospace. Aerospace systems undergo drastic changes in loading and storage conditions both during the launch of space structures as well as during their in-orbit operations. These transient conditions can lead to unexpected structural changes that can severely impact the performance and behavior of the systems. Investment in space travel and research is experiencing record growth because of expansion in the role of satellite communications, Internet of Things (IoT), space tourism, innovative space technologies, space debris mitigation etc. [7][8]. Space travel, research and exploration comes with its unique set of challenges and opportunities. Current design and testing methods assume same behavior of structures in orbit as on the ground which leads to increased stiffness requirement and parasitic mass. Also, to develop and sustain ecosystems critical for space exploration and expand satellite communications there is an increasing need to develop self-reconfigurable, resilient and fault-tolerant structure which can be easily transported, assembled, operated and extended without incurring large production or transportation costs. In many applications there are critical components connecting different assembles/parts together which may undergo fatigue/erosion resulting in system faults. Structural optimization with a specific pre-defined region of interest may prove inefficient to counteract faults that evolve over the duration of operation of the component. Ability to reconfigure from one state to another can play an important role in alleviating the negative effects of damage and bring structure back to its native healthy state [9]. On demand morphing can be achieved by stimuli responsive materials also called active or smart materials. Active (Smart) actuators are defined as actuators capable of reacting to an external stimulus. This stimulus can be in form of thermal gradient, pH change, light energy, magnetic field etc. The present invention investigate makes use of smart materials based actuators to design damage tolerant structures [10].

As further described in the section entitled “Further Detailed Embodiments” the claimed invention presents a multi-level topology optimization framework. The framework optimally places sensors and integrates the information from these optimally placed strain-type sensors into optimal placement of stimuli-sensitive actuators to design fault-tolerant structures. The designer is given the ability to develop a resilient structure with limited number of available sensors and limited number of available actuators with fixed actuation capabilities for different damage scenarios. The framework is independent of the type of smart material used to fabricate the actuators. A case study with shape memory polymers (SMP) as the active material has also been investigated to counteract the affects of the faults.

### Stimuli-Sensitive Actuators

A stimuli sensitive actuator is one that changes its shape in response to stimuli, including mechanical, thermal, magnetic, and electrical. As an example of a stimuli-sensitive actuator is “shape-memory polymers” (SMPs) that have the ability to return from a deformed state (temporary shape) to their original (permanent) shape when induced by an external stimulus (trigger), such as temperature change.

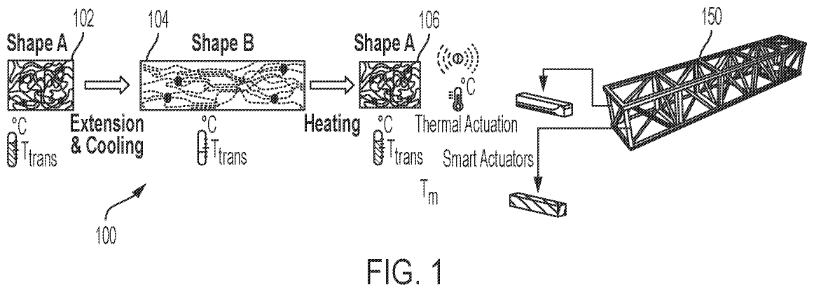

Turning now to FIG. 1, shown is an example of an actuator 102, 104, 106, that changes its shape in response to thermal stimuli as used in an active resilient truss structure 150 as shown.

Polymers exhibiting a shape-memory effect have both a current/temporary form and a stored/permanent form. These SMP contain at least two separate phases 1) one used for a permanent shape Tₚₑᵣₘ during manufacturing and 2) used for switching segments. The switching segments are shown in FIG. 1. The segments in Shape_A 102 with the ability to soften past a certain transition temperature (Tₜᵣₐₙₛ) and are responsible for the temporary shape (Shape_B) 104. Exceeding Tₜᵣₐₙₛ (while remaining below Tₚₑᵣₘ) activates the switching by softening these switching segments and thereby allowing the material to resume its original (permanent) form 106 (Shape_A). Below Tₜᵣₐₙₛ, the flexibility of the segments is at least partly limited. If Tₘ is chosen for programming the SMP, strain-induced crystallization of the switching segment can be initiated when it is stretched above Tₘ and subsequently cooled below Tₘ.

### Overview

Disclosed is a novel framework to place a fixed number of sensors and actuators automatically and optimally such that the system can reconfigure itself to neutralize the effects of structural faults. At high-level, the automated design process is as follows:
1. Sensor Placement Sensitivity Evaluation: Using adjoint sensitivity analysis, the relative importance of each sensor location with respect to the fault in each member is evaluated.
2. Sensor Location Optimization: Based on the sensor sensitivity information, the optimal location of the sensors are evaluated such that the maximum change in the structural behavior is observed with the minimum number of sensors.
3. Actuator Behavior Analysis: If actuator constitutive behavior is known, the stimuli-reactive force acting on the structure is obtained.
4. Fault Affect Evaluation: Based on the optimal sensor placement, the effects of the fault on any mission critical equipment is evaluated.
5. Smart Actuator Placement: Actuators are placed optimally to neutralize the effects of the faults.

### Non-Limiting Definitions

The terms “a”, “an” and “the” are intended to include the plural forms as well, unless the context clearly indicates otherwise.

The term “actuator” is a component of a machine that is responsible for moving and controlling a mechanism or system. Types of actuators include hydraulic, pneumatic, electric, thermal, mechanical, and soft actuators that change their shape in response to stimuli, including mechanical, thermal, magnetic, and electrical.

The term “additive manufacturing” is the construction of a three-dimensional object from a CAD model or a digital 3D model. It can be done in a variety of processes, including 3D printing, in which material is deposited, joined, or solidified under computer control, with material being added together (such as plastics, liquids, or powder grains being fused), typically layer by layer.

The phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The term “boundary condition” means is a location on a structure where either the external force or the displacement are known at the start of the analysis;

The term “connected” or “coupled” means an element is connected to another element, it can be directly connected or coupled to the other element or intervening elements may be present. In contrast, when an element is referred to as being “directly connected” or “directly coupled” to another element, there are no intervening elements present.

The term “design domain” reference to topology, size, shape, loading, boundary condition, and other criteria needed for a design of a structure

The term “design workflow” is a process of generating one or more designs of a part to comply with one or more of satisfying constraints while solving an optimization problem.

The term “optimization” or “preferred” is used to mean a better solution given the constraints, not necessarily the best or near best solution.

The term “optimization problem” is a problem in mathematics and computer science of finding the best solution or near-optimal solutions from all feasible solutions. Typically solving an optimization problem includes constraints, which set conditions for the variables that are required to be satisfied.

The term “passive resilient structure” means an active resilient structure whose control capability is reduced to zero or near zero or does not have control/actuation capability from the start.

The term “sensor” is a device that produces an output signal for the purpose of sensing a physical phenomenon. The sensor may include acoustic, chemical, ionization, electric, sound, vibration, pressure, force, flow, shape, thermal, and proximity. For example, a Bragg grating sensor network to monitor the morphing wing profile (shape sensing) and measure the strain actuation.

The term “shape-memory alloy” (SMA) is an alloy that can be deformed when cold but returns to its pre-deformed, i.e., “remembered” shape when heated.

The term “shape-memory polymers” (SMPs) are polymeric smart materials that have the ability to return from a deformed state (temporary shape) to their original (permanent) shape when induced by an external stimulus (trigger), such as temperature change.

The term “truss” is an assembly of members or bars, connected by nodes, that creates a structure.

### Stimuli-Sensitive Actuators

A soft actuator is one that changes its shape in response to stimuli, including mechanical, thermal, magnetic, and electrical. As an example of a stimuli-sensitive actuator is “shape-memory polymers” (SMPs) that have the ability to return from a deformed state (temporary shape) to their original (permanent) shape when induced by an external stimulus (trigger), such as temperature change.

Turning now to FIG. 1, shown is an example of an actuator 102, 104, 106, that changes its shape in response to thermal stimuli as used in an active resilient truss structure 150 as shown.

Polymers exhibiting a shape-memory effect have both a current/temporary form and a stored/permanent form. These SMP contain at least two separate phases 1) one used for a permanent shape Tₚₑᵣₘ during manufacturing and 2) used for switching segments. The switching segments are shown in FIG. 1. The segments in Shape_A 102 with the ability to soften past a certain transition temperature (Tₜᵣₐₙₛ) and are responsible for the temporary shape (Shape_B) 104. Exceeding Tₜᵣₐₙₛ (while remaining below Tₚₑᵣₘ) activates the switching by softening these switching segments and thereby allowing the material to resume its original (permanent) form 106 (Shape_A). Below Tₜᵣₐₙₛ, the flexibility of the segments is at least partly limited. If Tₘ is chosen for programming the SMP, strain-induced crystallization of the switching segment can be initiated when it is stretched above Tₘ and subsequently cooled below Tₘ.

### Overview

Disclosed is a novel framework to place a fixed number of sensors and actuators automatically and optimally such that the system can reconfigure itself to neutralize the effects of structural faults.

### Optimal Sensor Placement

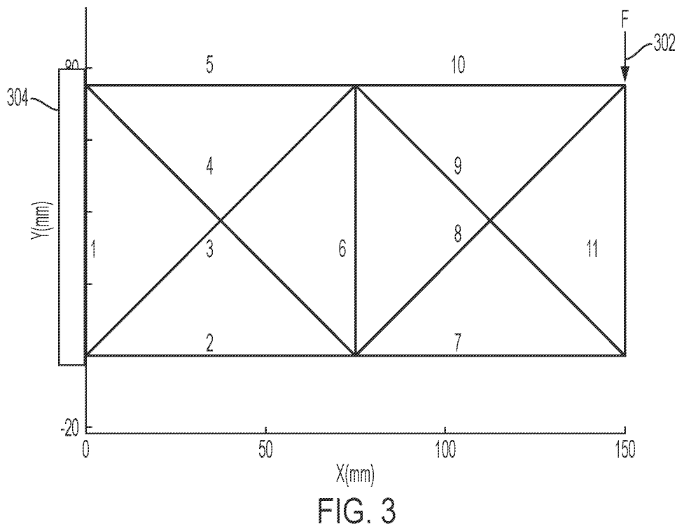

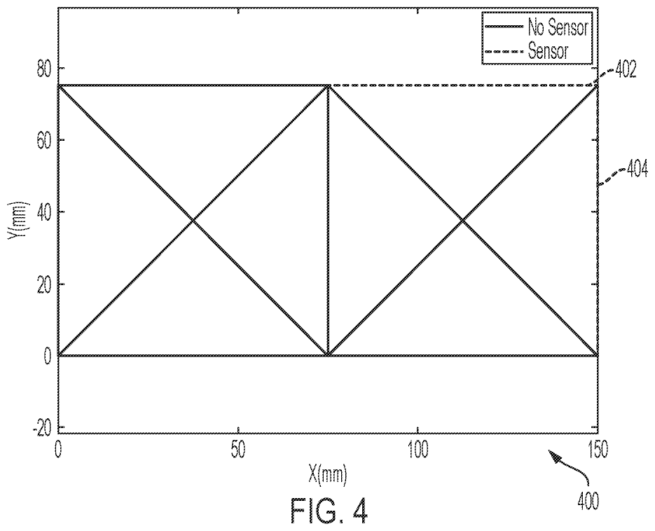

The effectiveness of the sensor placement is measured by a scalar parameter s, such that:

$$s = {\sum }_{i} {\sum }_{j} {S}_{ij} \qquad ( 1 )$$

Where Sᵢⱼ is a matrix, shown in FIG. 13, that stores the information on how much change in strain is measured by a sensor placed on the i^{th} bar as the area of j^{th} bar or truss member (x-axis) is changed. The matrix Sᵢⱼ is evaluated as:

$${S}_{ij} = \frac{d ‖ {ε}_{i} ‖}{d {A}_{j}} \qquad ( 2 )$$

Where d∥εᵢ∥ is the strain of the i^{th} bar and Aⱼ is the area of the j^{th} bar. The truss design domain with the boundary condition 304 and loading condition 302 is shown in FIG. 3. FIG. 4 is a truss structure 400 that illustrates the optimized placement of the sensor that maximized the parameter S under the constraint of the availability of only two sensors 402, 404, where sensors are shown in broken lines and non-sensors in solid lines.

### Actuator Analysis

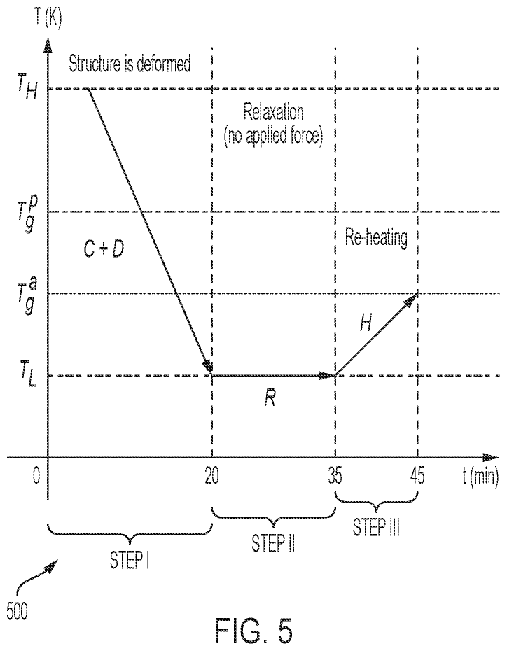

Active (Smart) actuators are defined as actuators capable of reacting to an external stimulus. This stimulus can be in the form of a thermal gradient, pH change, light energy, magnetic field, etc. Shape memory actuators (shape memory alloys or shape memory polymers) react to the external stimulus by a change in its displacement or change in the output force. In this framework, thermally actuated active actuators made with shape memory polymers (SMP) are considered. These actuators, when exposed to a thermal gradient, react by changing their displacement characteristics after they are programmed using a thermomechanical programming cycle. The steps of the thermomechanical programming cycle are shown below: FIG. 5 is a graph 500 illustrating the thermomechanical programming cycle used for the actuator. Here Tₐ^{g} is the glass-transition temperature of the active (SMP) material and Tₚ^{g} is the glass transition temperature of the passive material of the structure.
Step-I: The temperature is decreased from T_{H} to T_{L} while deforming the structure with a constant load F. This step is indicated with the label “C+D” in FIG. 5.
Step-II: The structure is allowed to relax without any external forces. This is labeled as “R” in FIG. 5.
Step-III: The structure is heated from T_{L} to T_{g}^{a}. This step is labeled “H” in FIG. 5.

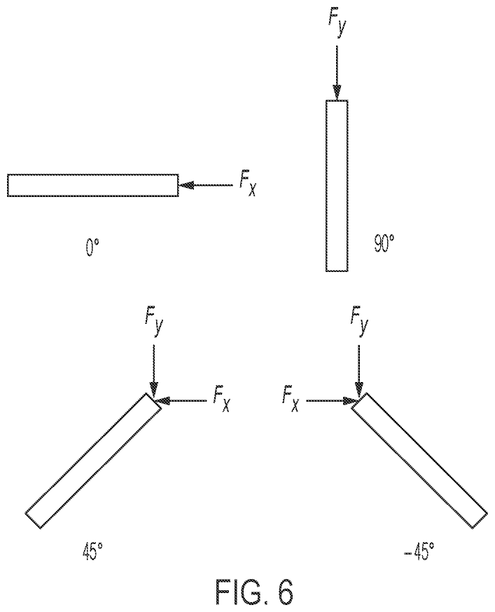

After Step-II, if the relaxed actuator is allowed to come back to its original configuration, then no output force is exerted by the material. An output force is extracted from the material to convert the SMP to an actuator by constraining the motion of the relaxed sample and implementing the Step-III with the free-end fixed. This constraint converts the potential displacement to an actuating force. The actuator is programmed to generate a compressive force at the end of the Step-III of the thermomechanical programming cycle. Depending on its position in the truss domain, an actuator can apply force in four possible ways, as shown in FIG. 6.

Two design variables are used for designing a structure with three materials: 1) Active SMP material 2) Passive auxiliary material 3) Void.

$${ρ}_{a} = \frac{{v}_{SMP}}{{v}_{s}} \qquad ( 3 )$$

Here, ρₐ represents the mixing ratio of the active SMP material and the volume of the solid material for each element. The term v_{SMP} represents the volume occupied by the SMP material inside the volume of the solid, represented as vₛ. The volume fraction of the solid material (ρₘ) is defined as:

$${ρ}_{m} = \frac{{v}_{s}}{V} \qquad ( 4 )$$

Here, V is the total volume of the element. The volume fraction of the SMP material is defined as:

$${ρ}_{SMP} = {ρ}_{a} {ρ}_{m} \qquad ( 5 )$$

Similarly, the volume fraction of the auxiliary material is defined as:

$${ρ}_{AUX} = ( 1 - {ρ}_{a} ) {ρ}_{m} \qquad ( 6 )$$

The effective Young's modulus (E) is defined using the SIMP scheme as shown below:

$$E = {ρ}_{SMP}^{p} {E}_{SMP} + {ρ}_{AUX}^{p} {E}_{AUX} + {E}_{void} \qquad ( 7 )$$

Here, p is the penalization parameter. The following assumptions are made, as enumerated below while developing the design framework.
1. An actuator applied the full force Fₐ whenever present in the structure.
2. The temperature and output force relation of the actuator is a complex nonlinear function, difficult and computationally expensive to evaluate but to simplify the design process, the output forces are assumed to be interpolated using the parameter ρ_{SMP} using the relation:

$$F = {ρ}_{SMP}^{q} {F}_{a} \qquad ( 8 )$$

Where q is a tuning parameter for force. More specifically, it is a parameter selected by the user to penalize the force. The value of this parameter affects whether a member is an actuator or just a passive material. The value of q will determine whether equation 8 is a linear or nonlinear simplification of the output force F.
3. The stiffness of the SMP material is smaller than the auxiliary material

$${E}_{void} < {E}_{SMP} < {E}_{AUX} \qquad ( 9 )$$

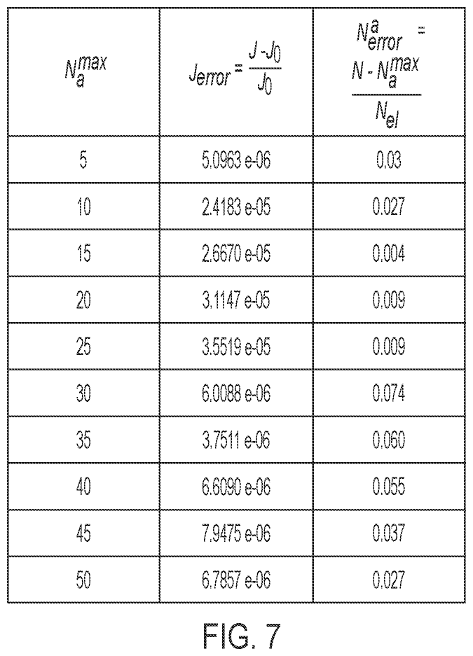

4. The decision of the optimizer to place even a small amount of active material on a bar results in the application of the full output force (Fₐ) and the bar stiffness to be E_{SMP}. This assumption is based on manufacturing constraints. Many times the designer might not be able to manufacture actuators with different stiffness levels or varied properties. Given the designer has only access to actuators with fixed stiffness values and predefined output force values, how can the actuators be placed to neutralize the negative effects of the faults. This provides a plug-and-play resilient design that can be useful in different scenarios.
   To design a structure, two types of information are extracted from the optimally placed sensors: 1) The state of a healthy structure (J₀). 2) The state of the faulty structure (J). The framework allows the users the freedom to simulate the location and the degree of the artificial faults.
   The design framework minimizes the difference between the faulty state and the healthy state by optimally placing smart actuators across the design domain, thus neutralizing the negative effects of the structural faults. FIG. 7 is an example table that compares the degree of closeness to which the faulty structure with the actuator placed optimally can reconfigure back to its healthy state, shown by the Jₑᵣᵣₒᵣ values for a structure with 215 elements. The column Nₑᵣᵣₒᵣ^{a} shows the error between the number of actuators used by the optimizer to reconfigure the structure, N, and the maximum number of actuators specified by the user, Nₐ^{max} in proportion to the maximum number of elements the structure has (Nₑₗ). The parameter N is calculated using only the effective number of actuators, i.e., the actuators which are part of the fixed boundary conditions are not used in the Nₑᵣᵣₒᵣ^{a} calculation.

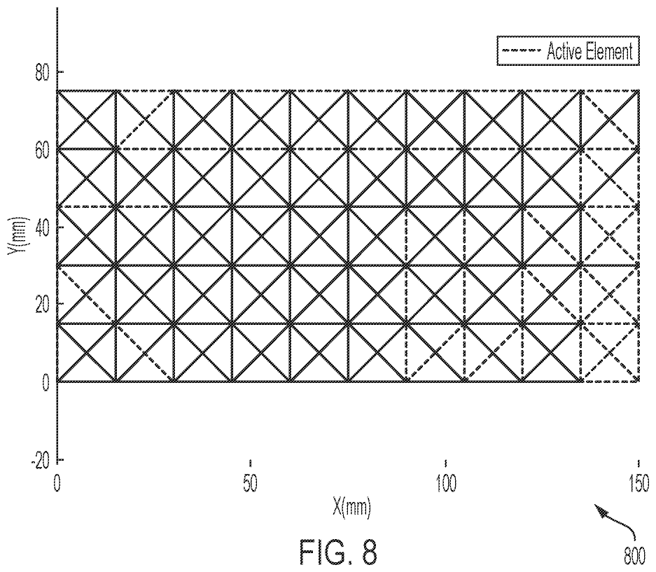

FIG. 8 shows the optimal position 800 of actuators to reconfigure a damaged truss structure back to its healthy state, where active element are illustrated in broken lines and non-active element illustrated as solid lines. The total number of truss members is 215. The boundary and loading conditions are similar to FIG. 3. The design optimization framework is shown in FIG. 8. The terms ρₛ and ρ_{A} represent the optimized solutions for the sensor and actuator placement problems.

### Simulating Different Types of Faults

In one example, using the present invention, different types of faults or damage can be simulated on a truss structure. For example, suppose a truss structure is to be deployed on a spacecraft to hold an antenna at a particular orientation in space. The truss structure does not need to be assembled beforehand. Rather different types of faults can be simulated. For example, in this example, space debris or meteorite impacts the truss structure, but the antenna orientation is required to remain constant. Then it is possible to plan by placing actuators and sensors such that even with the planned damage to the truss structure by a meteorite, the antenna will keep its required orientation based on the planned placement of actuators and sensors.

### Resilient Structure Design to Provide “Plug-n-Play” or Lego-Type Assembly

In one example of the present invention, the mathematical design workflow generates a manufacturing template defining the location of actuators and passive (non-actuating) members to produce the resilient truss structure. The actuator members and the passive members may be manufactured at the same location, say on Earth at Station #1. Or in the alternative, these actuator members and passive members can be manufactured at different locations, for example, Earth Station 1 and Earth at Station #2. Stated differently, either the actuators or the passive members or both the actuators and passive members can be manufactured anywhere, including multiple locations, provided their base material properties are the same.

After manufacturing these actuators and passive members, they can then be collected and assembled anywhere. This is where the plug-n-play or lego-type assembly analogy comes in. For example, the assembly may be required at a different location, on-site where the structure is deployed, or even in space if required. This plug-n-play assembly capability reduces transportation costs. Thus, this presents a system of distributed manufacturing and assembly like Lego® blocks for reconfigurable resilient structures.

### Flow Diagram for Designing Resilient Structures

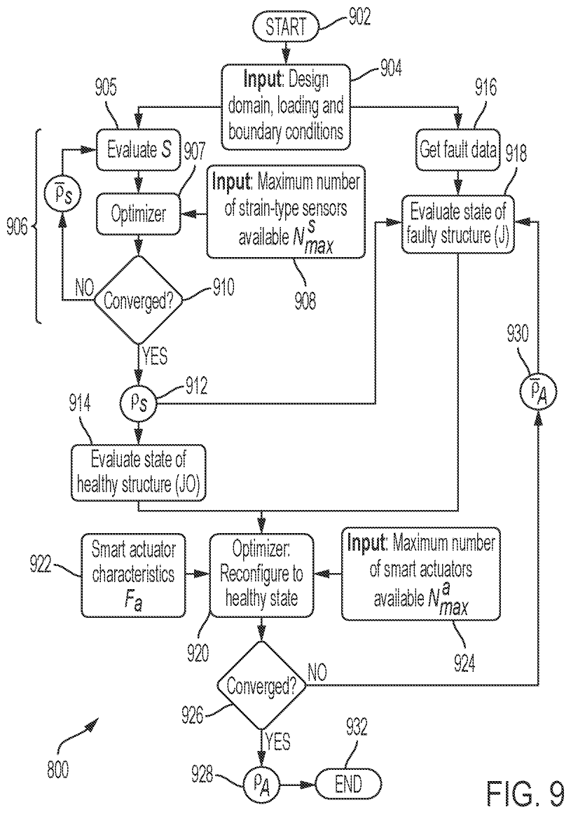

FIG. 9 is an example flowchart 900 describing the transfer of information between different modules of the framework is shown in FIG. 8 and, more specifically, the multi-level design optimization framework for fault-tolerant resilient structures. The process begins at step 902 and immediately proceeds to step 904.

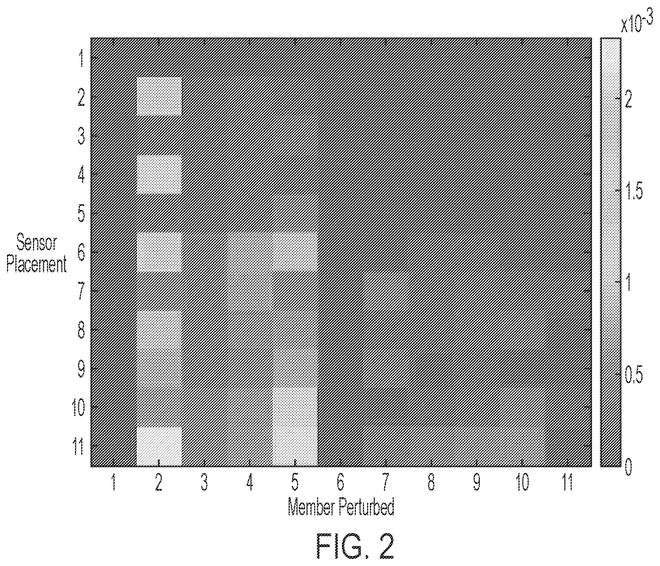

In step 904, an initial design domain for a truss structure formed from a plurality of members connected by nodes is received. In one example, the initial design domain for a truss structure is received with 1) boundary conditions, ii) loading conditions, or iii) both. This is described in equations 1 and equations 2 above with reference to matrix Sᵢⱼ. The process continues to step 906. In step 906, as shown in FIG. 2 and FIG. 3 the optimal position of sensors with providing maximum value of effectiveness s. The truss design domain with the boundary condition 304 and loading condition 302 is shown in FIG. 3. FIG. 4 is a truss structure 400 that illustrates the optimized placement of the sensor that maximized the parameter s under the constraint of the availability of only two sensors 402, 404.

Step 906 represents a loop 905, 907, 908, 910. Step 905 Sᵢⱼ is evaluated. Step 907 optimizer using input a maximum number of strain-type sensors available Nₘₐₓ^{s} and step 909 checks if the optimized solution converges. If the optimized solution has not converged, in step 909, ρ̅ₛ the compliment to the effective or optimal sensor position array ρₛ is feedback to step 905 as shown. The process continues to step 912.

In step 912, the effective or optimal sensor position array ρₛ is determined. The parameter ρₛ is a array of 0s and 1s. The bars where the optimizer determines to place sensors are represented as is and the others as 0s. The process continues to step 914.

A parallel path is shown in steps 916 and 918 is shown to evaluate fault data on the truss structure. To design a structure, two types of information are extracted from the optimally placed sensors: 1) The state of a healthy structure (J₀), step 914, and the state of the faulty structure (J) 918. The framework allows the users the freedom to simulate the location and the degree of the artificial faults. The process continues to step 920.

In step 920, the effective or optimal reconfigured to a healthy state. Also, in step 920, the characteristics of the smart actuators are received step 922, along with the maximum number of smart actuators available in step 924. These are optimized and reconfigured to a healthy state. A test to see if this converges in step 926. If the optimizer does not converge, then the complement ρ̅_̅{̅A̅}̅ (the information regarding placement of smart actuator bars in step 930 is feedback to step 918 as shown. Otherwise, if the optimizer in step 926 does converge, the process continues to step 928.

In step 928 the ρ_{A} contains the information regarding the placement of smart actuator bars, and the process ends in step 932.

In one example ρₐ and ρ_{A} can be the same or can differ by a scaling term depending on the design requirements. In this example ρₐ is used to denote a mixing ratio and ρ_{A} to denote the optimal placement of actuators. In this regard ρₐ=ρ_{A} but it can differ to make ρ_{A} in the algorithm of FIG. 9.

### Further Detailed Embodiments

### Nomenclature Used in this Further Detailed Embodiment

MMA Method of Moving Asymptotes
SMP Shape Memory Polymer
SIMP Solid Isotropic Material with Penalization
G Matrix capturing the sensitivity of sensor placement
MBB Messerschmitt-Bolkow-Blohm Beam
DMG Percentage of total bars damaged through cross-sectional area reduction
DT Damage Threshold
Nₘₐₓ^{a} Maximum number of available actuators
Nₘₐₓ^{s} Maximum number of available strain-type sensors
ρₛ Design variable associated with placement of sensors
ρₐ Design variable associated with placement of actuators
E Young's modulus of a truss member bar
Fₐ Force output of an actuator
N Number of member bars present inside the truss domain
J₀ Objective associated with a truss domain without any damaged/faulty member bars
J Objective associated with a truss domain with faulty member bars
J_{f} Objective associated with a truss domain consisting of faulty member bars
Jₒₚₜ Optimized value of objective associated
u Structural displacement vector
R Residual vector
A Cross-sectional area of each truss member bar
K Geometric stiffness matrix

### MORE DETAILED METHOD

### Problem Formulation

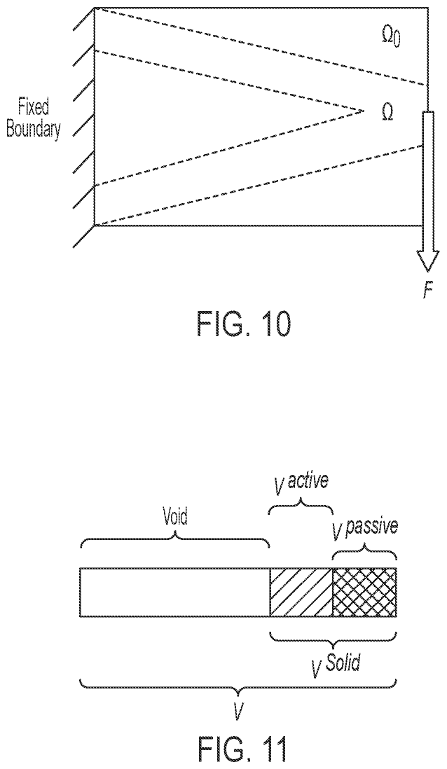

In topology optimization, a given amount of material is distributed within a fixed design domain in such a way that the objective function (θ₀), also known as the cost function, is minimized while satisfying a series of constraint functions (gᵢ). The design domain (Ω₀) contains all the possible design shapes. Let Ω represent one such design layout under the given boundary conditions and loading conditions as shown in FIG. 10.

The optimal material distribution is determined by carrying out the finite element analysis in combination with a SIMP (solid isotropic material penalization) scheme for material parameter interpolation. The general optimization problem can be formulated as:

$$\begin{matrix}{minimize}_{ρ} & {θ}_{0} ( ρ ) & \\ subjectto & {g}_{i} ( ρ ) \leq 0 & for i = 1 , 2 , … k \\ & {ρ}_{j}^{min} \leq {ρ}_{j} \leq {ρ}_{j}^{max} & for j = 1 , 2 , … l\end{matrix} \qquad ( 10 )$$

Here k and l represent the number of constraints and the number of variables respectively. In multi-material topology optimization, two design variables, m and ρ are used for designing a structure with 3 materials. These three materials, in this framework, are the active material, auxiliary material and the void material. For the formulation of the TO problem the material distribution inside a truss bar can be represented as shown in FIG. 11. In this study the active material is the SMP.

The variable m is the mixing ratio for a single truss bar and it is defined as shown below.

$$m = \frac{{V}_{active}}{{V}_{solid}} \qquad ( 11 )$$

Here, V_{active} and V_{sold} represents the volume occupied by the active material and the volume occupied by the solid material respectively, as shown in FIG. 11. The variable p represents the volume fraction of the solid material inside the truss member domain and is defined as shown below.

$$ρ = \frac{{V}_{solid}}{V} \qquad ( 12 )$$

Here, V is the total volume of the element. The volume fraction of the active material inside each truss member is defined as:

$${ρ}_{a} = {ρ}_{active} = ρ m \qquad ( 13 )$$

Similarly, the volume fraction of the passive (auxiliary) material for each truss member is defined as:

$${ρ}_{aux} = ( 1 - m ) ρ \qquad ( 14 )$$

The effective Young's modulus (E) for a truss member bar is defined using the SIMP scheme as shown below:

$$E = {ρ}_{active}^{p} {E}_{active} + {ρ}_{aux}^{p} {E}_{aux} + {E}_{void} \qquad ( 15 )$$

Here, p is the penalization parameter. The following assumptions are made, as enumerated below, while developing the design framework.
1. An actuator applies the full force Fₐ whenever present in the structure and the member bars apply the same constant force regardless of their orientation inside the truss domain i.e Fₐ=F₁=F₂=F₃.
2. The temperature and output force relation of the actuator is a complex nonlinear function, difficult and computationally expensive to evaluate, but to simplify the design process, the output force of a active truss member is assumed to be applied at the node and can be interpolated using the parameter ρ_{active} as shown below.

$$F = {ρ}_{active}^{q} {F}_{a} \qquad ( 16 )$$

3. The stiffness of the SMP material is smaller than the auxiliary material. To avoid numerical instability, the value of E_{void}=0.0001 GPa

$${E}_{void} < {E}_{active} < {E}_{aux} \qquad ( 17 )$$

4. The decision of the optimizer to place even a small amount of active material on a bar results in the application of the full output force (Fₐ) and decreasing the bar stiffness to E_{active}. This assumption is based on the design and manufacturing constraints. Many times the designer might not be able to manufacture actuators with different stiffness levels or varied properties. Assuming the designer has only access to actuators with fixed stiffness values and pre-defined output force values, how can the actuators be placed to neutralize the negative effects of the faults. This provides a plug-n-play resilient design which can be useful to different scenarios.

The framework is based on a bi-level design algorithm. The first level optimally places a fixed number of strain-type sensors over the truss domain based on the boundary and loading conditions so that maximum information regarding structural displacement can be extracted from them. Using the output of the first design level, two types of information are extracted: 1) The state of a healthy structure. 2) The state of the faulty structure. The second level of the design framework uses this data to optimally place smart actuators across the design domain to neutralize the negative affects of the structural faults. The algorithm describing the multi-level design optimization framework is shown in FIG. 9.

### Adjoint Sensitivity Analysis for Optimal Sensor Placement

To determine the optimal locations for sensor placement, the most important information required is the sensitivity of nodal displacements of each bar to the changes in the cross-sectional areas of all the bars. Mathematically this can parameter be defined as shown below.

$${S}_{ij} = \frac{d {Θ}_{i}}{{dA}_{j}} \qquad ( 18 )$$

The parameter Θ can represent any quantity of interest defined for a member bar. The value of both i and j can range from 1 to the total number of elements.

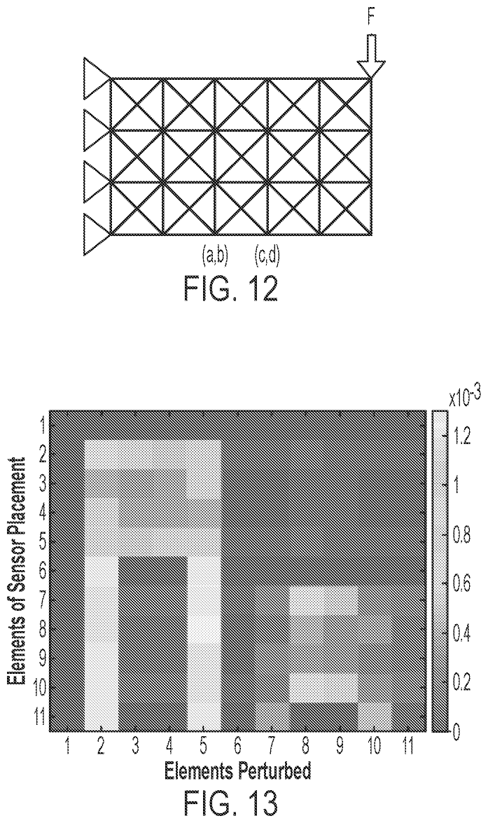

The sensitivity derivation process will be explained using FIG. 12. Let the ends of a bar have degrees-of-freedom (d.o.fs) a, b, c and d as shown. Let the displacement at the a^{th} degree-of-freedom for the i^{th} bar be defined as:

$$\begin{matrix}Θ = {u}_{i}^{a} \\ Θ = {Lu}_{f}\end{matrix} \qquad ( 19 )$$

Where the vector 1 is zero everywhere except at the d.o.f a, where its value is 1. The parameter u_{f} represents the displacement vector for the free degrees of freedom. The Lagrangian function ( [symbol] ) is formulated by adding the structural residual term with the function of interest whose sensitivity is required as shown below.

$$ℒ = {Lu}_{f} ( ρ , {f}_{ext}^{p} , {f}_{ext}^{f} ) + {λ}^{T} R ( ρ , {f}_{ext}^{p} , {f}_{ext}^{f} , {u}_{f} ) \qquad ( 20 )$$

The subscript f and p represents the free and fixed degrees-of-freedom, respectively. The parameter fₑₓₜ and R represents the external force and structural residual vectors respectively. The total derivative of the Lagrangian is evaluated using the chain-rule as shown below.

$$\frac{d ℒ}{d ρ} = L \frac{{du}_{f}}{d ρ} + L \frac{\partial {u}_{f}}{\partial {f}_{ext}^{p}} \frac{{df}_{ext}^{p}}{d ρ} + L \frac{\partial {u}_{f}}{\partial {f}_{ext}^{f}} \frac{{df}_{ext}^{f}}{d ρ} + {λ}_{f} \frac{\partial {R}_{f}}{\partial {u}_{f}} \frac{{du}_{f}}{d ρ} + {λ}_{f} \frac{\partial {R}_{f}}{\partial {f}_{ext}^{p}} \frac{{df}_{ext}^{p}}{d ρ} + {λ}_{f} \frac{\partial {R}_{f}}{\partial {f}_{ext}^{f}} \frac{{df}_{ext}^{f}}{d ρ} + {λ}_{f} \frac{\partial {R}_{f}}{\partial ρ} {λ}_{p} \frac{\partial {R}_{p}}{\partial {u}_{f}} \frac{{du}_{f}}{d ρ} + {λ}_{p} \frac{\partial {R}_{p}}{\partial {f}_{ext}^{p}} \frac{{df}_{ext}^{p}}{d ρ} + {λ}_{p} \frac{\partial {R}_{p}}{\partial {f}_{ext}^{f}} \frac{{df}_{ext}^{f}}{d ρ} + {λ}_{p} \frac{\partial {R}_{p}}{\partial ρ} \qquad ( 21 )$$

After collecting all the terms with implicit derivatives we obtain:

$$\frac{d ℒ}{d ρ} = ( L + {λ}_{f} \frac{\partial {R}_{f}}{\partial {u}_{f}} + {λ}_{p} \frac{\partial {R}_{p}}{\partial {u}_{f}} ) \frac{{du}_{f}}{d ρ} + ( L \frac{\partial {u}_{f}}{\partial {f}_{ext}^{p}} + {λ}_{f} \frac{\partial {R}_{f}}{\partial {f}_{ext}^{p}} + {λ}_{p} \frac{\partial {R}_{p}}{\partial {f}_{ext}^{p}} ) \frac{{df}_{ext}^{p}}{d ρ} + ( L \frac{\partial {u}_{f}}{\partial {f}_{ext}^{f}} + {λ}_{f} \frac{\partial {R}_{f}}{\partial {f}_{ext}^{f}} + {λ}_{p} \frac{\partial {R}_{p}}{\partial {f}_{ext}^{f}} ) \frac{{df}_{ext}^{f}}{d ρ} \qquad ( 22 )$$

Setting the coefficients of the terms containing implicit derivatives to zero and recognizing the fact that the external force is not dependent on the design variables p, we obtain.

$${λ}_{p} = 0 \qquad ( 23 )$$

$${λ}_{f} = - {LK}_{ff}^{- 1}$$

The sensitivity of the particular d.o.f with-respect-to the design variable is finally evaluated as:

$$\frac{d ℒ}{d ρ} = λ \frac{\partial R}{\partial ρ} \qquad ( 24 )$$

The above procedure is repeated for all the elements. This provides us with a matrix [symbol] . The x and y component of strain on the i^{th} element and its norm is measured as:

$${ε}_{x}^{i} = \frac{{u}_{c}^{i} - {u}_{a}^{i}}{{L}^{i}} \qquad ( 25 )$$

$${ε}_{y}^{i} = \frac{{u}_{d}^{i} - {u}_{b}^{i}}{{L}^{i}}$$

$$‖ {ε}^{i} ‖ = \frac{\sqrt{{( {u}_{c}^{i} - {u}_{a}^{i} )}^{2} + {( {u}_{d}^{i} - {u}_{b}^{i} )}^{2}}}{{L}^{i}}$$

The sensitivity of the norm of the strain for the i^{th} element with respect to all the design variables is calculated as:

$$G = {G}^{ij} = \vert \frac{d ‖ {ε}^{i} ‖}{d {ρ}^{j}} \vert = \vert \frac{1}{{L}^{i}} \frac{1}{2 \sqrt{{( {u}_{c}^{i} - {u}_{a}^{i} )}^{2} + {( {u}_{d}^{i} - {u}_{b}^{i} )}^{2}}} [ 2 ( {u}_{c}^{i} - {u}_{a}^{i} ) ( \frac{{du}_{c}^{i}}{d ρ} - \frac{{du}_{a}^{i}}{d ρ} ) + 2 ( {u}_{d}^{i} - {u}_{b}^{i} ) ( \frac{{du}_{d}^{i}}{d ρ} - \frac{{du}_{b}^{i}}{d ρ} ) ] \vert \qquad ( 26 )$$

The sensitivity analysis for actuator placement is performed using the finite difference method.

### Optimal Placement of Sensors and Smart Actuators

### Topology Optimization for Sensor Placement

To develop a framework for placement of sensors through topology optimization algorithm, the sensor matrix G is multiplied with a matrix of design variables D as shown below:

$$S = D G \qquad ( 27 )$$

Here D is a N×N matrix as shown below:

$$D = [ \begin{matrix}{ρ}_{s}^{1} & 0 & 0 & ⋯ & 0 \\ 0 & {ρ}_{s}^{2} & 0 & ⋯ & 0 \\ 0 & 0 & 0 & ⋯ & 0 \\ 0 & 0 & 0 & ⋯ & 0 \\ 0 & 0 & 0 & ⋯ & 0 \\ ⋮ & ⋮ & ⋮ & ⋱ & ⋮ \\ 0 & 0 & ⋯ & {ρ}_{s}^{N - 1} & 0 \\ 0 & 0 & 0 & ⋯ & {ρ}_{s}^{N}\end{matrix} ] \qquad ( 28 )$$

Here N is the number of elements in the design domain. The single scalar parameter that governs the placement of sensors on member bars is s, as shown below:

$$s = trace ( SI ) \qquad ( 29 )$$

where I is a N×N identity matrix. The parameter s is determined by first summing over all the columns of the matrix G. This summation of columns of the matrix G captures the effects of changes in area of each member bar (j) on the sensor placed at the member bar (i). This provides a vector with values capturing the effectiveness of the placement of sensor at each bar in terms of capturing faults. Then the vector is summed over all the entries to get a global effectiveness measure of sensor placement. This is represented mathematically by Equation 29.

Mathematically the topology optimization problem statement for optimal placement of sensors is written as:

$$\begin{matrix}{minimize}_{{ρ}_{s}} & - s \\ subjectto & {N}^{s} \leq {N}_{ma x}^{s}\end{matrix} \qquad ( 30 )$$

The term N^{s} represents the number of sensors placed by the optimization algorithm and is evaluated as:

$${N}^{s} = trace ( DI ) \qquad ( 31 )$$

The goal of the optimization framework is to identify the optimal placement of the given number of sensors such that the objective is maximized.

### Topology Optimization for Smart Actuator Placement

The sensor placement optimization algorithm provides the designer with an optimized set of sensor placement design variables ρₛ. This is then provided as an input to the smart actuator placement algorithm. The intermediate set of actuator placement design variable (ρ̅ₐ), as shown in Algorithm 13, is passed through a filter to transform it to a set of 0-1 variables in a continuous manner, as shown below.

$${\overline{ρ}}_{a} = \frac{tanh ( βη ) + tanh ( β ( {ρ}_{e} - η ) )}{tanh ( βη ) + tanh ( β ( 1 - η ) )} \qquad ( 32 )$$

Here, the parameters β=32 and η=0.05, respectively. The variable \hat{ρ}ₐ is same as the mixing ratio, m in Equation 14, and it is assumed that ρ=1 for all the elements. In field applications, any damage to the structure will be detected by the optimally placed sensors and the state of the structure will change from J₀, representing the native healthy state, to J, representing the damaged state. To mimick a structural fault, which can be due to erosion or crack, the cross-sectional areas of a certain number of random member bars, parameterized by a variable DMG as a percentage of the total number of bars present in the domain, are changed by a certain value and the subsequent value of J is evaluated. Let due to a fault the internal area of an element k changes by δAₖ. Mathematically this is implemented in the algorithm as shown below.

$${\overline{A}}^{i} = {A}^{i} ( 1 - D T ) \qquad ( 33 )$$

Here the parameter DT represents the percentage of damage for the individual bar i. The value of DT chosen in this study is 0.5. The algorithm takes the percentage damage undergone or likely to be undergone by the structure from the user to calculates the number of bars that needs to be removed to simulate the damage. After reducing the areas of the appropriate bars, finite-element analysis with the given boundary and loading conditions is performed and the nodal displacements of the bars which have a sensor associated with them, as dictated by ρₛ, is extracted to evaluate the health, J, of the faulty structure. The framework then optimally places smart actuators to neutralize the total displacement for all the specified degree-of-freedoms. Mathematically the optimization problem, for a design domain shown in FIG. 3, is written as:

$$\begin{matrix}{minimize}_{{\overline{ρ}}_{a}} & - J \\ subjectto & \begin{matrix}{N}^{a} \leq {N}_{ma x}^{a} \\ J \geq {J}_{0}\end{matrix}\end{matrix} \qquad ( 34 )$$

The parameter N^{a} is evaluated as:

$${N}^{a} = {\sum }_{i = 1}^{N} {\overline{ρ}}_{a}^{i} \qquad ( 35 )$$

The quantity J is defined as:

$$J = {L}_{a}^{T} u \qquad ( 36 )$$

The variable Lₐ is vector with values equal to 1 at the degrees-of-freedom of interest and 0 everywhere else. The variable u represents the displacement vector.

The parameter S, in Algorithm 13, represents the matrix capturing the sensitivity of nodal displacements of all the truss bars to change in the cross-sectional areas of all the other member bars. The variable ρₛ contains the information regarding the optimal placement of sensors on the truss members and ρ_{A} contains information regarding optimal placement of smart actuator bars. The parameter Nₘₐₓ^{a} represents the maximum number of actuators available and Fₐ represents the force output characteristic of the smart actuator, as mentioned before.

### Numerical Results

### Optimal Placement Strain Sensors

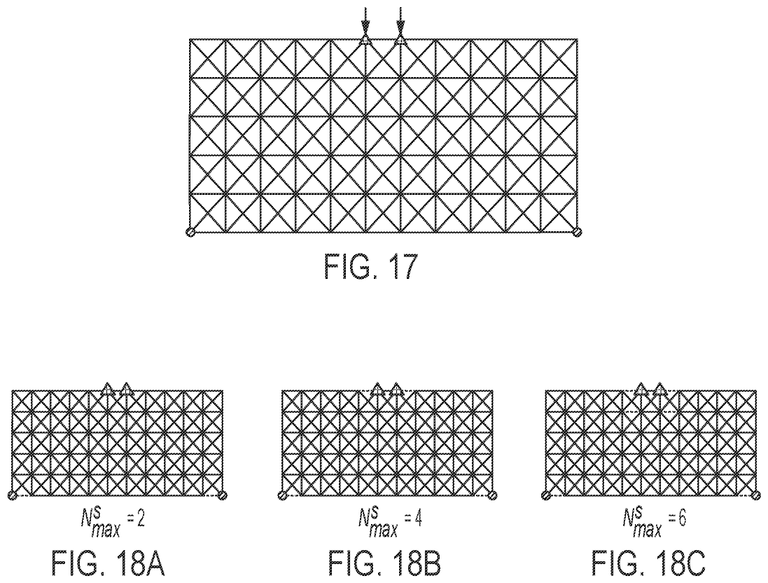

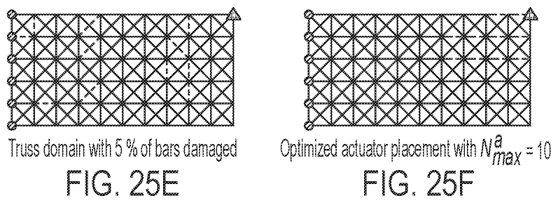

Let us consider a cantilever beam and a MBB beam as shown in FIG. 17 and FIG. 25. The markers illustrated as circles with hatching represent the fixed boundary nodes and the triangular marker represents the nodes at which the external forces are applied.

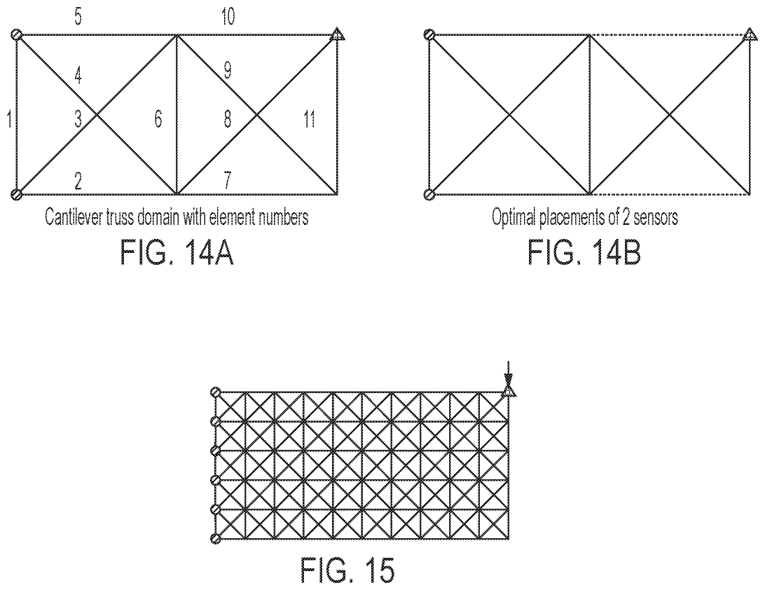

FIG. 13 shows the matrix G matrix for a cantilever truss with 11 elements. The placement of the sensors on the specific bars can be explained from the sensor matrix G in Figure FIG. 13. For a domain with 11 truss bars, with element numbers shown in FIG. 14A. The vector [symbol] , in Equation 37, represents the summation along each row for the matrix G. It is observed that the maximum values of the vector [symbol] occurs for the 7^{th} and 10^{th} rows which correspond to the 7^{th} and 10^{th} member bars respectively. Referring to the bar numbers of the design domain in FIG. 14b, the bars illustrated in dashed lines in FIG. 14a correspond to those bars.

$$𝒢 = [ \begin{matrix}0 \\ 0.002879 \\ 0.002033 \\ 0.002036 \\ 0.002875 \\ 0.002478 \\ 0.004396 \\ 0.003717 \\ 0.003672 \\ 0.004402 \\ 0.00334\end{matrix} ] \qquad ( 37 )$$

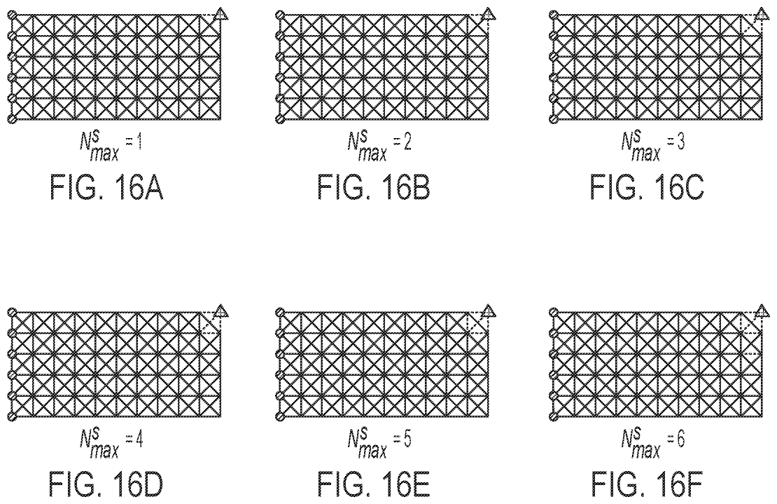

The optimal sensor placement for different Nₘₐₓ^{s} values, for a truss domain with 215 elements and different boundary and loading conditions, are shown in FIG. 16 and FIG. 18.

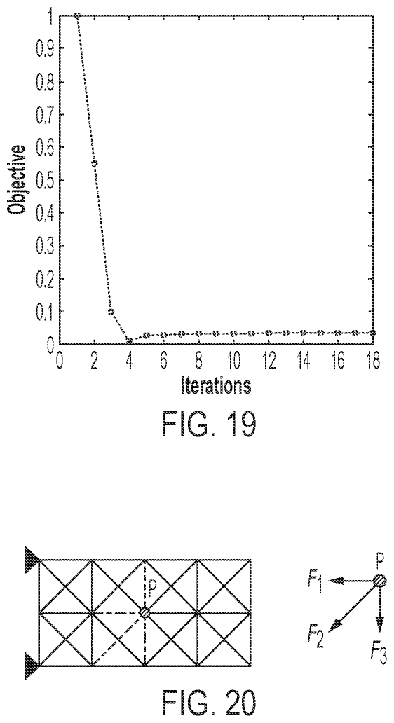

The illustrated in dashed lines colored bars represent the places where sensors are placed. The sensors can be placed at the nodes of the bars or at the mid-point. FIG. 19 shows the convergence plot for optimal sensor placement with Nₘₐₓ^{s}=4 with the KKT tolerance set to 10⁻⁵.

### Optimal Placement of Smart Actuators

### Shape Memory Polymer as the Active Material

The numerical results for the active actuator placement assume the active material to be a thermally actuated shape memory polymer. Shape memory actuators (shape memory alloys or shape memory polymers) react to the external stimulus by a change in its displacement or change in the output force. Thermally actuated active actuators made with shape memory polymers (SMP) are considered in this framework. These actuators when exposed to a thermal gradient react by changing their displacement characteristics after they are programmed using a thermomechanical programming cycle [17]. After the thermo-mechanical programming cycle, if the relaxed actuator is allowed to come back to its original configuration without any constraints then no output force is exerted by the smart member. However, if the actuated member is a part of a structure, it may not be free to come back to its original configuration, leading to a force exertion by the actuated member. Assume a node (shown illustrated as a circle with hatching in FIG. 20) connected to SMP actuators, then possible directions of force exerted on the node are shown in FIG. 20.

A output force is extracted from the material, to convert the SMP to an actuator, by constraining the motion the relaxed sample and implementing the application of thermal gradient with the free-end fixed. This constraint converts the potential displacement to an actuating force. The actuator is programmed to generate a compressive force at the end of the Step-III of the thermomechanical programming cycle.

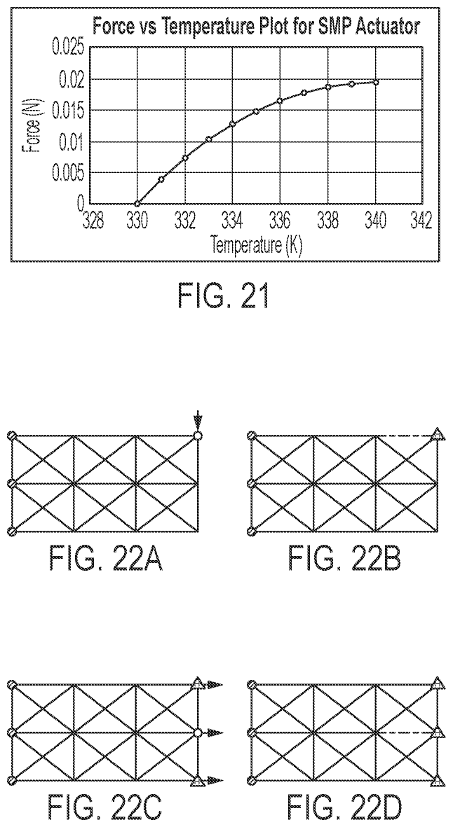

The relation between temperature and force output from a SMP actuator is shown in FIG. 21. This force and temperature correlation is obtained by running a finite element analysis [A17] of a 2D SMP sample with a length of 15 mm and a height of 3 mm. The shape memory characteristics is simulated by assuming that the sample domain comprises of only the SMP material and no passive material. The force output of the actuators in the truss domain (F₁, F₂, F₃) are picked from the plot in FIG. 21. The force Fₐ is this study is taken to be the maximum output force of 0.02 N. This assumes Eₛₘₚ=5 GPa and Eₐᵤₓ=15 GPa.

### Smart Actuator Placement Results

FIG. 22 shows a simple example problem of the optimal placement of smart actuators with Nₘₐₓ^{a}=1 with the objective of minimizing the displacement at the points shown in illustrated as white circle with no hatching markers for a structure without any structural damage under cantilever and uniaxial loading scenarios. The placement of actuator in FIG. 22b can be explained by the fact that since the actuators produce a compressive force, the top portion of the structure contracts causing the illustrated as white circle with no hatching point of interest to move upwards thereby counteracting the downward force on the cantilever structure. The placement of actuator in FIG. 22d is to counteract the positive applied forces to minimize the displacement of the node illustrated as white circle with no hatching.

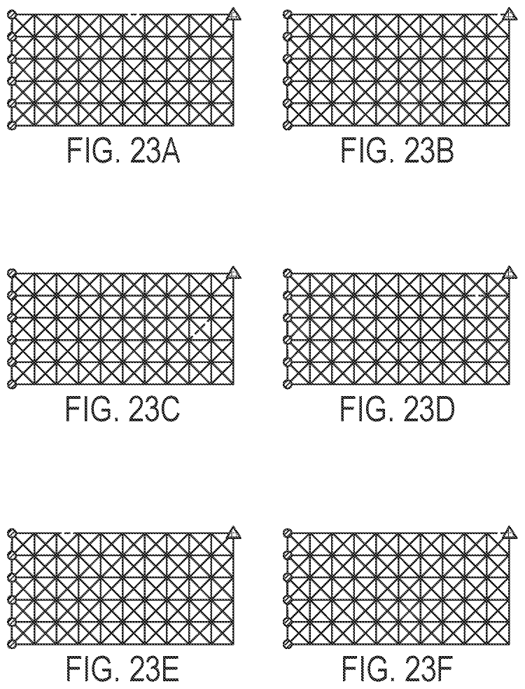

FIG. 23 shows a truss structure, with initial conditions shown in FIG. 15, with the same level of damage parameterized by the reduction in cross-sectional area of a single member bar (DMG=0.1%) by 50% (DT=0.5). The optimizer places the smart actuators, shown in illustrated in a dash line, to counteract the effects of the damage. The value of Nₘₐₓ^{a} is chosen to be 1. The effectiveness of the optimizer in the neutralizing the effects of the structural fault is tabulated in Table 1. The optimized distribution of the actuators reduces the severity of the damage by bring the value of J closer to J₀ from J_{f}.

TABLE 1
Comparison of the damaged optimized structural behavior
with the healthy structure with Nₘₐₓ^{a} = 1, DT = 0.5 and DMG = 0.1%

| J₀ | J_{f} | Jₒₚₜ |
|---|---|---|
| 7.7950 | 7.7058 | 7.7554 |
| 7.7270 | 7.7058 | 7.7058 |
| 7.9434 | 7.7058 | 7.9032 |

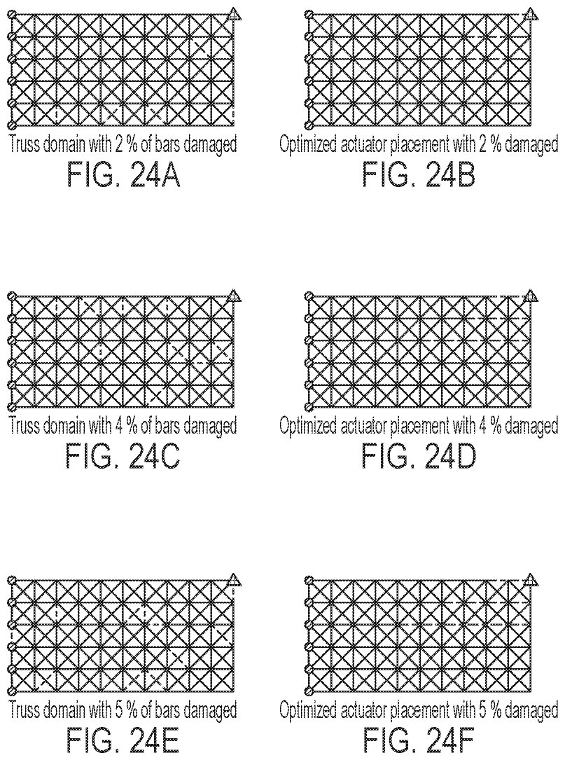

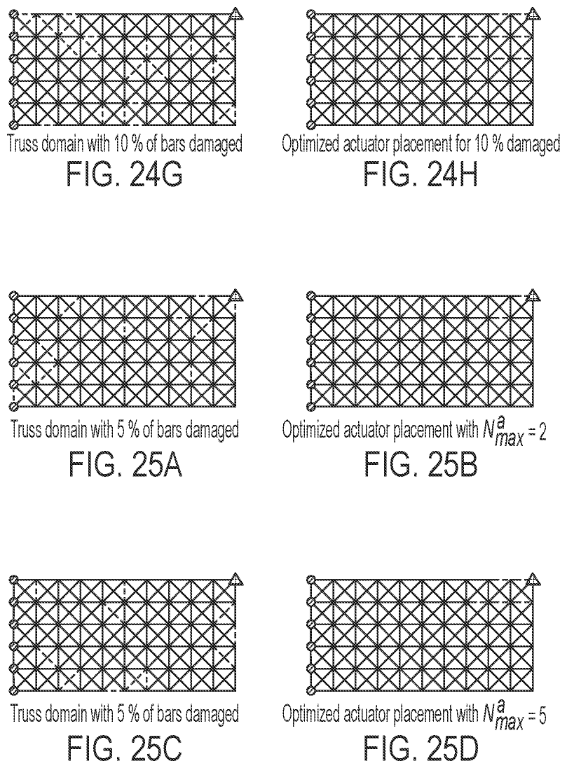

The different damage levels are simulated by random distribution of fixed number of bars across the domain. This is done keeping in mind that the sensors are not able to access the information regarding the location of damage but only the effects the damage level has on the structure. FIG. 45 investigates the effects of keeping the Nₘₐₓ^{a} constant and varying the levels of structural damage by changing the DMG values. The effectiveness of the optimization algorithm to neutralize different damage scenarios is tabulated in Table 2. From FIG. 24 it is observed that the optimal placement of smart actuators to neutralize effects of the higher damage levels automatically ensures that the structure is safe from lower levels of damage.

TABLE 2
Comparison of the damaged optimized structural behavior
with the healthy structure with Nₘₐₓ^{a} = 15, DT = 0.5
and variable levels of damage

| Nₘₐₓ^{a} | DMG (%) | J₀ | J_{f} | Jₒₚₜ |
|---|---|---|---|---|
| 15 | 2 | 7.7058 | 7.7710 | 7.7058 |
| 15 | 4 | 7.7058 | 7.8124 | 7.7058 |
| 15 | 5 | 7.7058 | 7.8483 | 7.7058 |
| 15 | 10 | 7.7058 | 9.0915 | 8.8660 |

FIG. 25 shows the effects of different Nₘₐₓ^{a} values on the optimal placement of smart actuators with the damage level held constant at DMG=5%. The associated values of the optimization results are tabulated in Table 3.

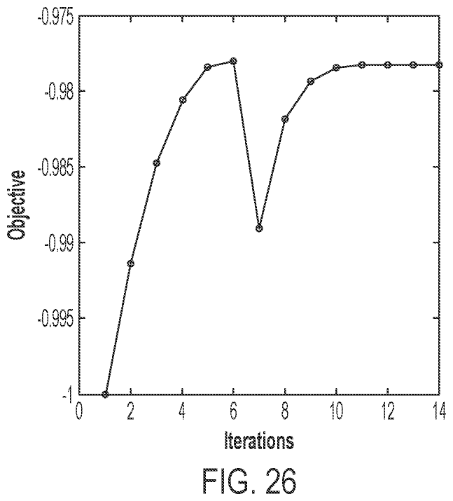

FIG. 26 shows the convergence plot for optimal placement of smart actuators inside a truss domain with initial conditions shown in FIG. 17 with 5% of member bars damaged and with Nₘₐₓ^{a}=10.

TABLE 3
Comparison of the damaged optimized structural behavior
with the healthy structure with DT = 0.5, DMG = 5% and
different values of Nₘₐₓ^{a}

| Nₘₐₓ^{a} | DMG (%) | J₀ | J_{f} | Jₒₚₜ |
|---|---|---|---|---|
| 2 | 5 | 7.7058 | 7.8677 | 7.8065 |
| 5 | 5 | 7.7058 | 8.0040 | 7.8791 |
| 10 | 5 | 7.7058 | 7.9714 | 7.8075 |

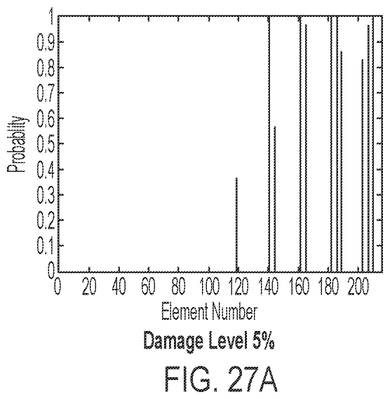

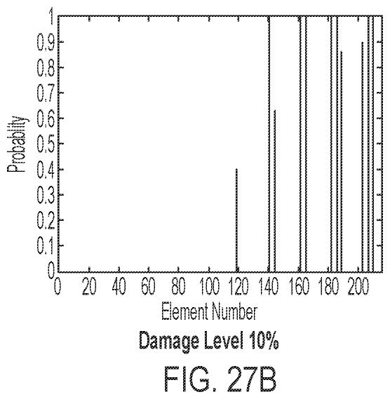

From FIG. 23 the position of defects plays a role in the optimal placement of smart actuators is observed. There has been cases, as seen in FIG. 14a and FIG. 14b, different locations of the structural fault can lead to the placement of actuator at the same position. To investigate this further, two case studies were performed. In the first case study the values of the number of damaged bars (DMG) and the damage threshold (DT) are kept constant and the optimization was run 30 times each with a different distribution of damaged member bars. This was repeated with DMG=10% and same damage threshold. The results are shown in FIG. 27. The value of Nₘₐₓ^{a} was held constant at 10. These results can be used to guide the placement of actuators depending on their maximum available numbers to effectively neutralize the influence to structural damage and return the structure to its native configuration.

### Conclusions

As shown above, the present invention provides a novel design optimization framework to generate damage tolerant resilient structures. The framework is based upon stimuli sensitive actuators. A case study with Shape Memory Polymer has been presented but the framework can be extended to optimize the placement of a variety of actuators made of active materials. The framework attempts to provide the structural designer to generate a self-reconfigurable with actuator units either having compression or tensile actuation characteristics. The framework consists of two levels. The first level (Level-I) implements a topology optimization algorithm to optimally place a fixed number of strain sensors to maximize their ability to detect changes in bar areas based on the loading and boundary conditions. The output of Level-I is a vector of variables specifying which truss members to be equipped with strain-sensors. This output is specified as an input to the second level (Level-II) of the design framework. This level also implements a topology optimization framework to optimally place a fixed number of actuators so that the faulty structure can be restored back to its native healthy state. The output of Level-II optimization is a vector specifying which truss members will be actuators to design a fault-tolerant structure. The framework is tailored to produce a crisp design where members bars can either be a actuator or not. This is in contrast to traditionally topology optimization frameworks where composites (a state between the two materials) are sometimes allowed owing to the ability of those structures to be 3D printed. However, a designer may not have access to such tools or the ability to control the ratio of the materials always. Examples of truss structures are given with different levels of damage and also show that the designs with lower levels of damage are a subset of the designs involving higher damage percentages. The current implementation may be extended to simultaneously design the structure with geometrical constraints along with optimizing the location of sensors and actuators. Structural designers are provided with an integrated framework to develop fault-tolerant structures for different boundary, loading as well as environmental conditions.

### Computer Hardware

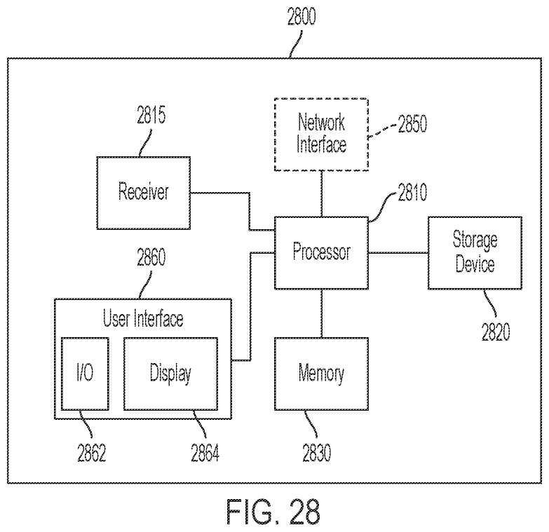

FIG. 28 The above-described methods can be implemented on a computer using well-known computer processors, memory units, storage devices, computer software, and other components. A high-level block diagram of such a computer is illustrated in FIG. 28. Computer 2800 contains a processor 2810, which controls the overall operation of the computer 2800 by executing computer program instructions that define such operation. The computer program instructions may be stored in a storage device 2820 (e.g., magnetic disk) and loaded into memory 2830 when execution of the computer program instructions is desired. Thus, the steps of the methods described herein may be defined by the computer program instructions stored in memory 2830 and controlled by the processor 2810 executing the computer program instructions. The computer 2800 may include one or more network interfaces 2850 for communicating with other devices via a network. The computer 2800 also includes a user interface 2860 that enables user interaction with the computer 2800. The user interface 2860 may include I/O devices 2862 (e.g., keyboard, mouse, speakers, buttons, etc.) to allow the user to interact with the computer. Such input/output devices 2862 may be used in conjunction with a set of computer programs as an annotation tool to annotate images in accordance with the embodiments described herein. The user interface also includes a display 2864 for displaying images and spatial realism maps to the user. According to various embodiments, FIG. 28 is a high-level representation of possible components of a computer for illustrative purposes, and the computer may contain other components.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

The various embodiments described above may be implemented using circuitry and/or software modules that interact to provide particular results. One of skill in the computing arts can readily implement such described functionality, either at a modular level or as a whole, using knowledge generally known in the art. For example, the flowcharts illustrated herein may be used to create computer-readable instructions/code for execution by a processor. Such instructions may be stored on a computer-readable medium and transferred to the processor for execution as is known in the art. The structures and procedures shown above are only a representative example of embodiments that can be used to facilitate embodiments described above.

### Non-Limiting Examples

Although specific embodiments of the invention have been discussed, those having ordinary skill in the art will understand that changes can be made to the specific embodiments without departing from the scope of the invention. The scope of the invention is not to be restricted, therefore, to the specific embodiments, and it is intended that the appended claims cover any and all such applications, modifications, and embodiments within the scope of the present invention.

It should be noted that some features of the present invention may be used in one embodiment thereof without use of other features of the present invention. As such, the foregoing description should be considered as merely illustrative of the principles, teachings, examples, and exemplary embodiments of the present invention, and not a limitation thereof.

Also, these embodiments are only examples of the many advantageous uses of the innovative teachings herein. In general, statements made in the specification of the present application do not necessarily limit any of the various claimed inventions. Moreover, some statements may apply to some inventive features but not to others.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

### INCORPORATED REFERENCES

The following publications and other references listed in the Information Disclosure are hereby incorporated by reference in their entirety:
[1] Bicheng Chen, Nianfeng Wang, Rixin Wang, Benliang Zhu, Xianmin Zhang, Wenjie Sun, and Wei Chen. Automatic design of dielectric elastomer based crawling robots using shape and topology optimization. Journal of Mechanisms and Robotics, pages 1-12, 2022.
[2] Xiuwen Fu, Pasquale Pace, Gianluca Aloi, Lin Yang, and Giancarlo Fortino. Topology optimization against cascading failures on wireless sensor networks using a memetic algorithm. Computer Networks, 177:107327, 2020.
[3] Yisi Liu, Xiaojun Wang, and Yunlong Li. Distributed piezoelectric actuator layout-design for active vibration control of thin-walled smart structures. Thin-Walled Structures, 147:106530, 2020.
[4] Odair Menuzzi, Jun SO Fonseca, Eduardo A Perondi, Juliano F Gonçlves, Eduardo Padoin, and Otávio A A Silveira. Piezoelectric sensor location by the observability gramian maximization using topology optimization. Computational and Applied Mathematics, 37(1):237-252, 2018.
[5] Ahmed Yaich, Fatma Abid, Tarek Merzouki, Abdelkhalak El Hami, Lassaad Walha, and Mohamed Haddar. A robust method for the reliability-based design optimization of shape memory alloy actuator. Mechanics Based Design of Structures and Machines, pages 1-19, 2021.
[6] Civil, H., Shift, R., and Carluccio, S., “What is critical infrastructure? why is resilience important?”, November 2021. URL https://www.resilienceshift.org/work-with-us/faqs/.
[7] “Out of this world: The future of space exploration and innovation,” July 2022. URL https://www.mckinsey.com/featuredinsights/themes/out-of-this-world-the-future-of-space-exploration-and-innovation.
[8] Porterfield, C., “Space industry grew to record 469 billion last year, report finds,” July 2022. URL https://www.forbes.com/sites/carlieporterfield/2022/07/27/space-industry-grew-to-record-469-billion-last-year-report-finds/?sh=1048637517f1.
[9] Reksowardojo, A. P., Senatore, G., and Smith, I. F., “Design of structures that adapt to loads through large shape changes,” Journal of Structural Engineering, Vol. 146, No. 5, 2020, p. 04020068.
[10] Schwartz, M., Smart materials, CRC press, 2008.
[11] Li, H., Li, H., Xiao, M., Zhang, Y., Fu, J., and Gao, L., “Robust topology optimization of thermoelastic metamaterials considering hybrid uncertainties of material property,” Composite Structures, Vol. 248, 2020, p. 112477.
[12] Asadpoure, A., Tootkaboni, M., and Guest, J. K., “Robust topology optimization of structures with uncertainties in stiffness—Application to truss structures,” Computers & Structures, Vol. 89, No. 11-12, 2011, pp. 1131-1141.
[13] Liu, Y., Wang, X., and Li, Y., “Distributed piezoelectric actuator layout-designfor active vibration control of thin-walled smart structures,” Thin-Walled Structures, Vol. 147, 2020, p. 106530.
[14] Menuzzi, O., Fonseca, J. S., Perondi, E. A., Gongalves, J. F., Padoin, E., and Silveira, O. A., “Piezoelectric sensor location by the observability gramian maximization using topology optimization,” Computational and Applied Mathematics, Vol. 37, No. 1, 2018, pp. 237-252.
[15] Yaich, A., Abid, F., Merzouki, T., El Hami, A., Walha, L., and Haddar, M., “A robust method for the reliability-based design optimization of shape memory alloy actuator,” Mechanics Based Design of Structures and Machines, 2021, pp. 1-19.
[16] Fang, C., and Wang, W., Shape memory alloys for seismic resilience, Springer, 2020.
[17] Chen, B., Wang, N., Wang, R., Zhu, B., Zhang, X., Sun, W., and Chen, W., “Automatic Design of Dielectric Elastomer Based Crawling Robots Using Shape and Topology Optimization,” Journal of Mechanisms and Robotics, 2022, pp. 1-12.
[13] Zhang, X., Takezawa, A., and Kang, Z., “Topology optimization of piezoelectric smart structures for minimum energy consumption under active control,” Structural and Multidisciplinary Optimization, Vol. 58, No. 1, 2018, pp. 185-199.
[14] Townsend, S., Grigg, S., Picelli, R., Featherston, C., and Kim, H. A., “Topology optimization of vibrational piezoelectric energy harvesters for structural health monitoring applications,” Journal of intelligent material systems and structures, Vol. 30, No. 18-19, 2019, pp. 2894-2907.
[15] Fu, X., Pace, P., Aloi, G., Yang, L., and Fortino, G., “Topology optimization against cascading failures on wireless sensor networks using a memetic algorithm,” Computer Networks, Vol. 177, 2020, p. 107327.
[16] Lumpe, T. S., and Shea, K., “Computational design of 3D-printed active lattice structuresfor reversible shape morphing,” Journal of Materials Research, Vol. 36, No. 18, 2021, pp. 3642-3655.
[17] Bhattacharyya, A., and James, K. A., “Topology optimization of shape memory polymer structures with programmable morphology,” Structural and Multidisciplinary Optimization, Vol. 63, No. 4, 2021, pp. 1863-1887.

What is claimed is:

1. A computer-implemented method for placing sensors on an active resilient structure design, comprising:
receiving an initial design domain for a truss structure formed from a plurality of members connected by nodes, the members include passive structures and structures formed with stimuli sensitive actuators;
creating a mathematical array of sensor placement sensitivity by successively measuring, for each respective sensor disposed on a respective member of a plurality of members comprising the truss structure, a respective relative change in structural response based on applying respective faults on other members of the plurality of members other than the respective member;
iteratively using the mathematical array of sensor placement sensitivity to evaluate different locations for groups of sensors disposed on the plurality of members in the truss structure, to measure a change in the structural response until at least one of i) a predefined number of stimuli sensitive actuators is reached, ii) a predefined number of sensors is reached, iii) a predefined computational budget is reached, and iv) a predefined computational performance is reached;
identifying, based on the evaluation of different locations of each sensor, locations of a fewest number of sensors in the groups of sensors that produce a relatively larger measured change in the structural response for a given location of a fault; and
producing a design workflow to generate one or more active resilient structure designs based on the locations of the fewest number of sensors that produce the relatively larger measured change in the structural response, in order to neutralize the effects of a simulated fault on the truss structure.

2. The computer-implemented method of claim 1, wherein the receiving the initial design domain for a truss structure includes receiving the initial design with at least one of 1) boundary conditions and ii) loading conditions.

3. The computer-implemented method of claim 1, wherein the producing the design workflow to generate one or more designs of with placement of stimuli sensitive actuators includes at least one of i) actuators that change their shape in response to stimuli, ii) passive material that does not change its shape in response to stimuli, and iii) materials that have one or more voids.

4. The computer-implemented method of claim 1, wherein the producing the design workflow to generate one or more designs of with placement of stimuli sensitive actuators includes simplifying a modeling an output force of a stimuli sensitive actuator in response to stimuli as a linear equation.

5. The computer-implemented method of claim 1, wherein the receiving an initial design domain for the truss structure includes receiving at least one of boundary conditions, and loading conditions; and
wherein the producing the design workflow to generate one or more designs with placement of actuators includes producing the design workflow for a one or more portions based on the at least one of boundary conditions and loading conditions.

6. The computer-implemented method of claim 1, wherein the producing the design workflow to generate one or more designs includes producing the design workflow to specify members of the truss structure without actuators are fabricated at a first manufacturing location and the design workflow to specify members of the truss structure with actuators that change their shape in response to stimuli are fabricated in a second manufacturing location, and the truss structure is assembled at the second manufacturing location, wherein the first manufacturing location and the second manufacturing location are geographically different.

7. The computer-implemented method of claim 1, wherein the simulated fault on the truss structure further comprises:
receiving one or more simulated faults; and
evaluating the one or more designs produced by the design workflow to identify a design that the neutralize at least a portion of the effects of the one or more simulated faults on the truss structure.

8. The computer-implemented method of claim 1, wherein the producing the design workflow to generate one or more designs to use additive manufacturing to form one or more of the actuators.

9. The computer-implemented method of claim 1, wherein the producing the design workflow to generate one or more designs includes producing the design workflow to specify members of the truss structure with actuators that change their shape in response to stimuli are fabricated at a first manufacturing location and to specify members of the truss structure without actuators are fabricated in a second manufacturing location, wherein the first manufacturing location and the second manufacturing location are geographically different.

10. The computer-implemented method of claim 1, wherein the producing the design workflow to generate one or more designs includes producing the design workflow to specify two or more distinct manufacturing locations for fabricating at least two of the plurality of members of the truss structure and assembling these fabricated truss members in a third location to form the truss structure, wherein the distinct manufacturing locations and the third location are each geographically different.

11. An information processing system for placing sensors on an active resilient structure design, the information processing system comprising:
a computer memory capable of storing machine instructions; and
a hardware processor in communication with the computer memory, the hardware processor configured to access the computer memory to execute the machine instructions to perform
receiving an initial design domain for a truss structure formed from a plurality of members connected by nodes, the members include passive structures and structures formed with stimuli sensitive actuators;
creating a mathematical array of sensor placement sensitivity by successively measuring, for each respective sensor disposed on a respective member of a plurality of members comprising the truss structure, a respective relative change in structural response based on applying respective faults on other members of the plurality of members other than the respective member;
iteratively using the mathematical array of sensor placement sensitivity to evaluate different locations for groups of sensors disposed on the plurality of members in the truss structure, to measure a change in the structural response until at least one of i) a predefined number of stimuli sensitive actuators is reached, ii) a predefined number of sensors is reached, iii) a predefined computational budget is reached, and iv) a predefined computational performance is reached;
identifying, based on the evaluation of different locations of each sensor, locations of a fewest number of sensors in the groups of sensors that produce a relatively larger measured change in the structural response for a given location of a fault; and
producing a design workflow to generate one or more active resilient structure designs based on the locations of the fewest number of sensors that produce the relatively larger measured change in the structural response, in order to neutralize the effects of a simulated fault on the truss structure.

12. The system of claim 11, wherein the receiving the initial design domain for a truss structure includes receiving the initial design with at least one of 1) boundary conditions and ii) loading conditions.

13. The system of claim 11, wherein the producing the design workflow to generate one or more designs of with placement of stimuli sensitive actuators includes at least one of i) actuators that change their shape in response to stimuli, ii) passive material that does not change its shape in response to stimuli, and iii) materials that have one or more voids.

14. The system of claim 11, wherein the producing the design workflow to generate one or more designs of with placement of stimuli sensitive actuators includes simplifying a modeling an output force of a stimuli sensitive actuator in response to stimuli as a linear equation.

15. The system of claim 11, wherein the receiving an initial design domain for the truss structure includes receiving at least one of boundary conditions and loading conditions; and
wherein the producing the design workflow to generate one or more designs with placement of actuators includes producing the design workflow for a one or more portions based on the at least one of more boundary conditions and loading conditions.

16. The system of claim 11, wherein the producing the design workflow to generate one or more designs includes producing the design workflow to specify members of the truss structure without actuators are fabricated at a first manufacturing location and the design workflow to specify members of the truss structure with actuators that change their shape in response to stimuli are fabricated in a second manufacturing location, and the truss structure is assembled at the second manufacturing location, wherein the first manufacturing location and the second manufacturing location are geographically different.

17. The system of claim 11, wherein the simulated fault on the truss structure further comprises:
receiving one or more simulated faults; and
evaluating the one or more designs produced by the design workflow to identify a design that the neutralize at least a portion of the effects of the one or more simulated faults on the truss structure.

18. The system of claim 11, wherein the producing the design workflow to generate one or more designs to use additive manufacturing to form one or more of the actuators.

19. The system of claim 11, wherein the producing the design workflow to generate one or more designs includes producing the design workflow to specify members of the truss structure with actuators that change their shape in response to stimuli are fabricated at a first manufacturing location and to specify members of the truss structure without actuators are fabricated in a second manufacturing location, wherein the first manufacturing location and the second manufacturing location are geographically different.

20. The system of claim 11, wherein the producing the design workflow to generate one or more designs includes producing the design workflow to specify two or more distinct manufacturing locations for fabricating at least two of the plurality of members of the truss structure and assembling these fabricated truss members in a third location to form the truss structure, wherein the distinct manufacturing locations and the third location are each geographically different.
